(19) United States
(12) Patent Application Publication
(10) Pub. No.: US 2025/0002814 A1
(43) Pub. Date: Jan. 2, 2025

(54) CAR WASH COMPOSITION

(71) Applicant: The Procter & Gamble Company, Cincinnati, OH (US)

(72) Inventors: Sean Michael RENOCK, Loveland, OH (US); Kristi Lynn CARITHERS, Liberty Township, OH (US)

(21) Appl. No.: 18/757,612

(22) Filed: Jun. 28, 2024

Related U.S. Application Data
(60) Provisional application No. 63/511,317, filed on Jun. 30, 2023.

(51) Int. Cl. C11D 1/83; C11D 1/12; C11D 1/72; C11D 1/94; C11D 3/00; C11D 3/20; C11D 3/37; C11D 17/00

(52) U.S. Cl. CPC C11D 1/83; C11D 1/12; C11D 1/72; C11D 1/94; C11D 3/0047; C11D 3/2086; C11D 3/373; C11D 17/0008; C11D 2111/14

(57) ABSTRACT

A composition for washing cars, where the composition comprises one or more surfactants, where the one or more surfactants comprise a nonionic surfactant, an anionic surfactant, and an amphoteric surfactant, an optional hydrophobic benefit agent, and an optional stabilizing agent, as well as a rinse-free method of cleaning a car using the composition.

### CROSS REFERENCE TO RELATED APPLICATIONS

This application claims the benefit, under 35 U.S.C. § 119(e), to U.S. Provisional Application No. 63/511,317, filed Jun. 30, 2023, the entire disclosure of which is fully incorporated by reference herein.

### FIELD OF THE INVENTION

A composition for washing cars, where the composition comprises one or more surfactants, where the one or more surfactants comprise a nonionic surfactant, an anionic surfactant, and an amphoteric surfactant, an optional hydrophobic benefit agent, and an optional stabilizing agent, as well as a rinse-free method of cleaning a car using the composition.

### BACKGROUND OF THE INVENTION

A car represents a considerable expense for most consumers and many consumers take pride in the maintenance and appearance of their cars. Many consumers follow meticulous cleaning regimens to maintain the appearance of their cars and maximize their enjoyment of the cars. Regular cleaning and/or detailing may also help to preserve a car's finish.

The washing of a car can be a time-consuming and labor-intensive undertaking. Professional washing and/or detailing, though it frees the consumer from the task of washing and/or detailing, can be prohibitively expensive, particularly if performed on a regular basis. Some consumers may not want to budget for expensive, regular professional washing and/or detailing. Other consumers simply enjoy and take pride in washing their own cars.

Hand washing a car generally involves wetting the car's surface, for example, using a garden hose, applying a ready-to-use cleaning composition to the car's surface or diluting a concentrated cleaning composition in water (e.g., in a bucket) and then applying the diluted (ready-to-use) composition to car's surface. The cleaning composition may be applied using a cleaning implement, such as a sponge, and scrubbing the car's surface with the cleaning implement. After cleaning, the car's surface is typically rinsed, using the garden hose, and air dried or towel dried. Importantly, a standard garden hose (without an automatic shutoff nozzle) may use about 10 gallons of water per minute, which adds up to 100 gallons of water for only a 10-minute car wash. A traditional commercial car wash, without water conservation equipment, may use between 15 and 85 gallons per vehicle.

Modern consumers are more concerned about reducing the environmental impact of household products, which includes reducing water usage in the context of car washing. Moreover, consumers still expect a car wash product that is efficacious. And, though a car enthusiast may not be dismayed at the prospect of spending several hours cleaning or detailing his or her car, a typical consumer is seeking a car wash product that is fast and easy to use. A car wash product that allows for one bucket washing is designed to address the need for a product that is fast and easy to use, as well as the need for a product that enables reduced water usage.

One bucket car washing and one bucket car wash products are known. Generally, a one bucket washing process, unlike a traditional washing process (such as described above), does not require a rinsing step or a hose for rinsing. One bucket car washing may be performed inside a garage and anywhere with access to 1 to 2 gallons of water. The one bucket wash process generally utilizes a wash solution, which contains 1 to 2 gallons of water and a prescribed amount of a cleaning composition, a cleaning implement, such as a towel, e.g., a microfiber towel, to clean the car, and, optionally, a second towel to dry the car. The cleaning towel helps to loosen and collect dirt particulates on the car's surface and, as such, tends to get visibly dirty. The dirty towel may signal to the consumer that the towel should be soaked and washed in the wash solution. The dirty towel may release dirt particulates into the wash solution, and the particulates tend to precipitate out of the wash solution and settle at the bottom of the bucket. Soaking and/or washing the towel in the wash solution yields a visibly clean, reusable towel.

However, with some existing products that are marketed as “one bucket” wash products, consumer may perceive that the product does not sufficiently remove dirt, including oily dirt, from the towel and consumers may avoid reusing the towel after soaking in the bucket of wash solution for fear of redepositing dirt on the surface of the car, making hazy spots on the car, or even damaging or scratching the car's surface. Protection of the car's surface is an important concern for many consumers. Other existing one bucket car wash product are marketed to car enthusiasts and not optimized for use by a typical consumer, who generally has less experience cleaning a car. For example, a typical consumer may not be able to discern if the product is effectively cleaning the car's surface.

High suds volume may be an effective and desirable signal of cleaning. In the context of hand-washing a car, high suds volume may be especially desirable since the consumers may directly feel and touch suds generated during the washing process and may intuitively correlate high suds volume with effective cleaning. Paradoxically, a high volume of suds generated and maintained during the car washing process, may signal a need to rinse the car with copious amounts of water, in order remove any residual cleaning composition from the car's surface. Consequently, a typical consumer may feel the need to rinse the car, using a garden hose, for example, until the suds have completely disappeared, signaling that the car is clean and free of cleaning composition residue. Such rinsing requires additional water, time, and labor on the part of the consumer and erodes the benefits of the one bucket wash.

There is a need to provide consumers with an improved car wash product and process that provides a delightful hand washing experience, requires less water, and is quick and easy to use, to enable more frequent washes. Specifically, there is a need for a car wash product that generates an optimal amount of suds that is sufficient to signal cleaning efficacy without signaling a need to rinse the car.

### SUMMARY OF THE INVENTION

The present disclosure relates to a car wash composition comprising: a. from about 1% to about 30% by weight of the composition of one or more surfactants, where the one or more surfactants comprise: i. from about 1% to about 15%, preferably about 2% to about 10%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof; ii. from about 1% to about 15% by weight of the composition of a nonionic surfactant selected from the group consisting of a linear or branched C9-C15 ethoxylated alcohol surfactant having about 5 to about 12 units of ethylene oxide per mole of alcohol, a C8-C16 alkyl polyglucoside, preferably where about 10% to about 75% by weight of the C8-C16 alkyl polyglucoside is C10 alkyl polyglucoside, having a number average degree of polymerization of from about 0.5 to about 3.0, preferably about 1.0 to about 2.0, and mixtures thereof; and iii. from about 0.1% to about 5% by weight of the composition of an amphoteric surfactant; b. from about 0.1% to about 5% by weight of the composition of a hydrophobic benefit agent selected from the group consisting of a wax, a silicone oil, and mixtures thereof; c. from about 0.01% to about 0.5% trihydroxystearin; and d. water; where the pH of the composition is about 6 to about 9.

The present disclosure also relates to a car wash composition comprising: a. from about 1% to about 30% by weight of the composition of one or more surfactants, wherein the one or more surfactants comprise: i. from about 1% to about 15%, preferably about 2% to about 10%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof; ii. from about 1% to about 15% by weight of the composition of a C8-C16 alkyl polyglucoside, preferably where about 10% to about 75% by weight of the C8-C16 alkyl polyglucoside is C10 alkyl polyglucoside, having a number average degree of polymerization of from about 0.5 to about 3.0, preferably about 1.0 to about 2.0; and iii. from about 0.1% to about 5% by weight of the composition of an amphoteric surfactant; where the pH of the composition is about 6 to about 9.

The present disclosure also relates to a car wash composition comprising: a. from about 99.00% to about 99.99% by weight of the composition of water; b. from about 0.0021% to about 0.6% by weight of the composition of one or more surfactants comprising: i. from about 0.001% to about 0.3%, preferably about 0.001% to about 0.2%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof; ii. from about 0.001% to about 0.3% by weight of the composition of a nonionic surfactant selected from the group consisting of a linear or branched C9-C15 ethoxylated alcohol surfactant having about 5 to about 12 units of ethylene oxide per mole of alcohol, a C10 alkyl polyglucoside surfactant having a number average degree of polymerization of from about 0.5 to about 3.0, preferably about 1 to about 2, and mixtures thereof; and iii. from about 0.0001% to about 0.1% by weight of the composition of an amphoteric surfactant; c. from about 0.00001% to about 0.1% by weight of the composition of a hydrophobic benefit agent selected from the group consisting of a wax, a silicone oil, and mixtures thereof; and d. from about 0.000001% to about 0.01% trihydroxystearin; wherein the pH of the composition is about 6.5 to about 7.5 and, preferably, wherein the composition is a ready-to-use or dilute composition.

### BRIEF DESCRIPTION OF THE DRAWINGS

FIG. 1 is a photograph showing the towel reference scale for the Towel Rating Method disclosed herein, with 0 indicating a clean towel and 6 indicating the dirtiest towel.

### DETAILED DESCRIPTION OF THE INVENTION

### Definitions

As used herein, “suds” indicates a non-equilibrium dispersion of gas bubbles in a relatively smaller volume of a liquid. The terms like “suds”, “foam” and “lather” can be used interchangeably within the meaning of the present invention.

As used herein, articles such as “a” and “an” when used in a claim, are understood to mean one or more of what is claimed or described.

As used herein, the terms “comprising,” “comprises,” “include”, “includes” and “including” are meant to be non-limiting. The term “consisting of” is meant to be limiting, i.e., excluding any components or ingredients that are not specifically listed except when they are present as impurities. The term “consisting essentially of,” on the other hand, allows the presence of other components or ingredients as long as they do not interfere with the functions of those components or ingredients that are specifically listed.

As used herein, the term “substantially free of” or “substantially free from” means that the indicated material is not deliberately added to the composition, or preferably not present at analytically detectable levels. It is meant to include compositions whereby the indicated material is present only as an impurity of one of the other materials deliberately added.

All temperatures herein are in degrees Celsius (° C.) unless otherwise indicated. Unless otherwise specified, all measurements herein are conducted at 20° C., and under the atmospheric pressure.

Unless otherwise noted, all component or composition levels are in reference to the active portion of that component or composition, and are exclusive of impurities, for example, residual solvents or by-products, which may be present in commercially available sources of such components or compositions.

In all embodiments of the present invention, all percentages are by weight of the total composition, unless specifically stated otherwise. All ratios are weight ratios, unless specifically stated otherwise. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It has been discovered that a cleaning composition containing one or more surfactants, where the one or more surfactants comprise a nonionic surfactant, an anionic surfactant, and an amphoteric surfactant, and, optionally, a hydrophobic benefit agent and a stabilizing agent, provides a more effective car wash product, as well as an improved manual car washing experience that requires less water and is quick and easy (thereby enabling more frequent washes). The cleaning compositions disclosed herein also generate an optimal amount of suds that is sufficient to signal cleaning efficacy without signaling a need to rinse the car.

### Car Wash Composition

The car wash composition may be a manual (hand) car-washing composition in liquid form that is diluted prior to use. The car wash composition is preferably an aqueous composition. The car wash composition may comprise from about 50% to about 95% water, or from about 60% to about 90%, or from about 70% to about 85% water, all by weight of the composition. A dose of the car wash composition may be diluted, e.g., with about 2 L to about 16 L, or from about 3 L to about 12 L, or from about 4 L to about 8 L of water, to produce a wash solution that comprises about 99.00% to about 99.99% water. A dose of the car wash composition may contain from about 5 g to about 100 g, or from about 10 g to about 75 g, or from about 20 g to about 50 g of the composition.

The pH of the composition may be from about 5.0 to about 10.0, preferably from about 6.0 to about 9.0, as determined by the pH Test Method, described herein. The pH of the composition may be adjusted using pH modifying ingredients known in the art. The car wash composition may be diluted, e.g., with about 4 L to about 8 L of water, to produce a ready-to-use car wash composition having a pH of about 6.5 to about 7.5, as determined by the pH Test Method, described herein.

The composition may have a yield stress greater than about 0.005 Pa and less than about 0.5 Pa at 40° C., and greater than or equal to about 0.2 Pa and less than about 0.5 Pa at 25° C. The composition may have a viscosity of from about 1 mPa·s to about 500 mPa·s, preferably from about 5 mPa·s to about 200 mPa·s, more preferably from about 5 mPa·s to about 100 mPa·s, at a shear rate of 10 1/sec and at 40° C., as measured according to the Rheological Measurement Method disclosed herein.

The compositions of the present disclosure may comprise renewable components and exhibit good performance, such as cleaning and suds mileage. The compositions disclosed herein may comprise from about 1%, or from about 5%, or from about 10%, or from about 20% or from about 30%, of from about 40% or from about 50%, to about 40%, or to about 50%, or to about 60% or to about 70% or to about 80% or to about 90%, or to about 100% by weight of renewable components. The compositions disclosed herein may be at least partially or fully bio-based, As such, the composition can comprise a bio-based carbon content of about 50% to about 100%. preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived surfactants, petroleum-derived solvents, or other petroleum-derived agents (e.g., waxes). The compositions of the present disclosure may be substantially free of surfactants derived from petroleum-derived alcohols.

### Surfactant

The car wash composition(s) of the present disclosure may comprise from about 1% to about 40%, preferably from about 1% to about 30%, more preferably from about 1% to about 25%, by weight of the total composition of one or more surfactants. The car wash composition(s) of the present disclosure may comprise different combinations of the upper and lower percentages described above or combinations of any value in the ranges listed above of one or more surfactants. The one or more surfactants may be selected from the group consisting of an anionic surfactant, a nonionic surfactant, an amphoteric surfactant, a zwitterionic surfactant, and combinations thereof.

The weight ratio of nonionic surfactant to anionic surfactant in the car wash composition(s) may be greater than or equal to 2:1 or greater than or equal to 3:1. The weight ratio of nonionic surfactant to anionic surfactant in the car wash composition(s) may be from about 2:1 to about 20:1, preferably about 2:1 to about 10:1, more preferably about 2:1 to about 5:1.

### Anionic Surfactant

The car wash composition(s) may comprise an anionic surfactant. The car wash composition(s) may comprise from about 1% to about 15%, preferably about 2% to about 10%, by weight of the composition of an anionic surfactant. The car wash composition(s) may comprise different combinations of the upper and lower values described above or combinations of any value in the ranges listed above by weight of the composition of the anionic surfactant.

The anionic surfactant may be selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap (fatty acids and/or salts thereof), and mixtures thereof. The anionic surfactant may be selected from the group consisting of alpha-olefinsulfonate, alkyl sulfate, and combinations thereof.

The car wash composition(s) may comprise one or more alkyl sulfate anionic surfactants of the formula R¹—O—SO₃M, where R¹ is a linear fatty alcohol consisting of carbon chain lengths of from about C6 to about C20, preferably from about C8 to about C18, more preferably from about C10 to about C16, even more preferably from about C12 to about C14 or about C12 to about C13, where M (counter ion) is an alkali metal, preferably Na or K, an earth alkali metal, preferably Mg, or ammonium or alkanolamine, e.g., monoethanolamine, cation. The alkyl sulfate anionic surfactant may be dodecyl sulfate.

The alkyl chain of the alkyl sulfate anionic surfactant may have a mol fraction of C12-C14 chains of at least about 50%, or at least about 65%, or at least about 80%, or at least about 90%, where the mol fraction of C12-C14 chains in the alkyl sulfate anionic surfactant may be derived from the carbon chain length distribution of the surfactant. The carbon chain length distribution of the alkyl chains of the alkyl sulfate anionic surfactants may be obtained from technical data sheets from the suppliers for the surfactant or constituent alkyl alcohol. Alternatively, the chain length distribution and average molecular weight of the fatty alcohols, used to make the alkyl sulfate anionic surfactant, may also be determined by methods known in the art. Such methods include capillary gas chromatography with flame ionization detection on medium polar capillary column, using hexane as the solvent. The chain length distribution is based on the starting alcohol and the alkyl sulfate anionic surfactant should be hydrolyzed back to the corresponding alkyl alcohol before analysis (for instance using hydrochloric acid).

The fatty alcohol portion of the alkyl sulfate (R¹) may be petroleum derived or derived from a renewable source (e.g., plant derived, such as natural oil). The fatty alcohol portion of the alkyl sulfate (R¹) may be derived from a natural oil, such as coconut oil, palm kernel oil, palm oil, or a mixture thereof. Fatty alcohols derived from a renewable source may be referred to as natural fatty alcohols. Natural fatty alcohols are linear and have an even number of carbon atoms with a single alcohol (—OH) attached to the terminal carbon. The natural fatty alcohol portion of the surfactant (R¹) may comprise distributions of even number carbon chains, e.g., C8, C10, C12, C14, C16, C18, and so forth. The natural fatty alcohol portion of the surfactant (R¹) may comprise a single even number chain length, e.g., C12 only. For example, using a single chain length alcohol as starting material, a corresponding single chain length alkyl sulfate will result. Though, it may be advisable to utilize mixtures of alcohols having a distribution of carbon chain length around a selected mean. This will, of course, provide a mixture of alkyl sulfates having the same distribution of chain lengths around the mean. The natural fatty alcohol portion of the surfactant (R¹) may comprise C12 and C14 chains.

The compositions disclosed herein may comprise one or more than one type of alkyl sulfates; the different types of alkyl sulfate may differ in carbon chain length distribution and number average carbon chain length. The compositions disclosed herein may be a single sourced alkyl sulfate or may comprise a mixture of alkyl sulfates, where the single sourced material or mixture may have a number average (arithmetic mean) carbon chain length within the range of about 10 to about 16 carbon atoms, preferably about 12 carbon atoms to about 14 carbon atoms. It is understood that an alkyl sulfate anionic surfactant of the formula R¹—O—SO₃M may be a single chain length surfactant, e.g., CH₃(CH₂)₁₁—O—SO₃M, or a subfraction of chain lengths, preferably a C12-C14 subfraction. A single sourced alkyl sulfate, which is fractionated to maximize the C12 and C14 alkyl chain lengths, may be used.

The alkyl sulfate surfactant may be alkoxylated or free of alkoxylation. When alkoxylated, the alkyl sulfate anionic surfactant may have an average degree of alkoxylation of less than about 3.5, or from about 0.3 to about 2.0, or from 0.5 to 0.9. When alkoxylated, ethoxylation is preferred. The average degree of alkoxylation is the mol average degree of alkoxylation (i.e., mol average alkoxylation degree) of all the alkyl sulfate anionic surfactant. Hence, when calculating the mol average alkoxylation degree, the mols of non-alkoxylated sulfate anionic surfactant are included:

Mol average alkoxylation degree=(x1*alkoxylation degree of surfactant 1+x2*alkoxylation degree of surfactant 2+ . . . )/(x1+x2+ . . . )

where x1, x2, . . . are the number of moles of each alkyl (or alkoxy) sulfate anionic surfactant of the mixture and alkoxylation degree is the number of alkoxy groups in each alkyl sulfate anionic surfactant. Preferred alkyl (or alcohol) alkoxy sulfates are alkyl (or alcohol) ethoxysulfates. The width of the alkoxylation distribution of an alkoxylated alkyl sulfate anionic surfactant may affect the surfactant's cleaning performance, sudsing, low temperature stability, as well as the viscosity of the finished product. The alkoxylation distribution, including its broadness can be varied through the selection of catalyst and process conditions when making the alkoxylated alkyl sulfate anionic surfactant.

The alkyl sulfate or alkyl alkoxy sulfate surfactant may have a weight average degree of branching of from about 5% to about 60%, or from about 15% to about 60%, or from about 20% to about 60%. The alkyl sulfate or alkyl alkoxy sulfate may comprise at least about 5%, or at least about 10%, or at least about 25%, by weight of the alkyl sulfate or alkyl alkoxy sulfate, of branching on the C2 position (as measured counting carbon atoms from the sulfate group for non-alkoxylated alkyl sulfate anionic surfactants, and the counting from the alkoxy-group furthest from the sulfate group for alkoxylated alkyl sulfate anionic surfactants). Greater than 75%, or greater than 90%, by weight of the total branched alkyl content may consist of C1-C5 alkyl moieties, preferably C1-C2 alkyl moieties. Formulating car wash compositions using alkyl sulfates or alkyl alkoxy sulfates having the aforementioned degree of branching results may provide improved low temperature stability. Such compositions may require less solvent in order to achieve good physical stability at low temperatures. The weight average branching, described herein, may also provide improved suds generation and/or suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

where x1, x2, . . . are the weight in grams of each alcohol in the total alcohol mixture of the alcohols which were used as starting material before (alkoxylation and) sulphation to produce the alkyl (alkoxy) sulfate anionic surfactant. In the weight average degree of branching calculation, the weight of the alkyl alcohol used to form the alkyl sulfate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionization detection on medium polar capillary column, using hexane as the solvent. The weight average degree of branching and the distribution of branching is based on the starting alcohol used to produce the surfactant.

Suitable examples of commercially available alkyl sulfate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols may be blended in order to achieve the desired mol fraction of C₁₂-C₁₄ chains and the desired ratio of chain lengths, based on the relative fractions of each chain length present within the starting alcohols, as obtained from the technical data sheets from the suppliers or from analysis using methods known in the art.

Anionic alkyl sulfonate or sulfonic acid surfactants suitable for use herein include the acid and salt forms of alkylbenzene sulfonates, alkyl ester sulfonates, primary and secondary alkanesulfonates, such as paraffin sulfonates, alpha-olefinsulfonate or internal olefinsulfonates, alkyl sulfonated (poly)carboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates especially C5-C20 methyl ester sulfonates, C6-C22 primary or secondary alkane sulfonates, C5-C20 sulfonated (poly)carboxylic acids, and any mixtures thereof, but preferably C11-C13 alkylbenzene sulfonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulfonates include paraffin sulfonates and other secondary alkane sulfonate (such as Hostapur SAS60 from Clariant).

Alkyl sulfosuccinate and dialkyl sulfosuccinate esters are organic compounds with the formula MO3SCH(CO2R′)CH2CO2R where R and R′ can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated.

### Nonionic Surfactant

The car wash composition(s) may comprise from about 1% to about 20%, preferably from about 2% to about 15%, or different combinations of the upper and lower values described above or combinations of any value in the ranges listed above, by weight of the composition of a nonionic surfactant.

The car wash composition(s) may comprise one or more nonionic surfactants and one or more anionic surfactants, preferably where the weight ratio of the nonionic surfactant to the anionic surfactant in the car wash composition(s) may be greater than about 2:1, greater than about 3:1, from about 2:1 to about 20:1, or from about 2:1 to about 10:1, or from about 2:1 to about 5:1, or different combinations of the upper and lower ratios described above or combinations of any ratio in the ranges listed above.

Suitable nonionic surfactants include alkyl polyglucosides, alkoxylated alcohols, alkoxylated alkyl phenols, alkoxylated fatty acids, alkoxylated fatty esters or oils, alkoxylated amines or fatty acid amides, fatty acid esters of polyhydroxy compounds, including glycerol/sorbitol/sucrose, or mixtures thereof. The nonionic surfactant may be selected from the group consisting of ethoxylated alcohols, alkoxylated alcohols, preferably alkyl polyglucosides, and mixtures thereof.

The alkoxylated alcohol nonionic surfactant may be a linear or branched, primary or secondary alkyl alkoxylated nonionic surfactant, preferably an alkyl ethoxylated nonionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol. The alkoxylated alcohol may be selected from the group consisting of linear or branched C9-C15 ethoxylated alcohol surfactants having about 5 to about 12 units of ethylene oxide per mole of alcohol.

If alkoxylated alcohol or alkoxylated alkyl sulfate, particularly ethoxylated alcohol or ethoxylated alkyl sulfate is present in the composition, without wishing to be bound by theory, through tight control of processing conditions and/or feedstock material compositions, during the ethoxylation (and sulfation, in the case of ethoxylated alkyl sulfate) step(s), the amount of 1,4-dioxane by-product within the ethoxylated alcohol (or ethoxylated alkyl sulfate) can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alcohols and alkyl sulfates have been described extensively in the art. Alternatively 1,4-dioxane level may be controlled within a formulation, as described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof. Preferably, the compositions disclosed herein are substantially free of 1,4-dioxane.

Alkyl polyglucoside nonionic surfactants may be preferred, as they are believed to generate more sudsing than other nonionic surfactants, such as alkyl ethoxylated alcohols. An alkyl polyglucoside or alkyl glucoside (also referred to as alkyl polyglycoside or alkyl glycoside) surfactant generally has a hydrophobic alkyl group containing from about 6 to about 30 carbon atoms, preferably from about 8 to about 16 carbon atoms, and a hydrophilic saccharide or polysaccharide, e.g., glucoside or polyglucoside, group. An alkyl (poly)glucoside generally has the following structure: R(O)(G)ₓ (I), in which the radical R is a linear or branched C6-C30 alkyl radical; G represents a reduced saccharide comprising from 5 to 6 carbon atoms; and x indicates the degree of polymerization and is a value ranging from 1 to 10, preferably 1 to 5. G may be selected from the group consisting of glucose, dextrose, saccharose, fructose, galactose, maltose, maltotriose, lactose, cellobiose, mannose, ribose, dextran, talose, allose, xylose, levoglucan, cellulose, starch, and mixtures thereof, preferably G is glucose. As used herein, the term “alkyl polyglucoside” includes alkyl monosaccharides (e.g., alkyl glucosides) (degree of polymerization 1) and alkyl polysaccharide (e.g., alkyl polyglucosides) (degree of polymerization greater than 1).

The hydrophobic alkyl portion of the alkyl polyglucoside (R, in Formula I) may contain a distribution of carbon chain lengths, such as a distribution of even number carbon chains, e.g., C8, C10, C12, C14, C16, C18, and so forth. Preferably, hydrophobic alkyl portion of the surfactant (R, in Formula I) contains a distribution of chain lengths, ranging from about 6 carbon atoms to about 18 carbon atoms, preferably ranging from about 8 carbon atoms to about 16 carbon atoms. An alkyl polyglucoside surfactant having a broad distribution of chain lengths (also referred to as broad range), for example, C8-C16 or C8-C14, is preferred to an alkyl polyglucoside surfactant having a narrower distribution of chain lengths, for example, C8-C10, C12-C16, or C12-C14. Broad range alkyl polyglucosides may improve wetting, cleaning, and/or low residue upon drying.

The alkyl polyglucoside (APG) surfactant may be selected from C8-C18 alkyl polyglucosides, preferably C8-C16 alkyl polyglucosides, having a number average degree of polymerization of from about 0.1 to about 3.0, preferably from about 0.5 to about 3.0, more preferably from about 1.0 to about 2.0, even more preferably from about 1.2 to about 1.6. The alkyl polyglucoside surfactant may have a number average carbon chain length of about 10 carbon atoms to about 12 carbon atoms. About 1% to about 98%, or from about 2% to about 85%, or from about 3% to about 75%, or from about 4% to about 65%, or from about 5% to about 50%, or from about 5% to about 45%, or from about 5% to about 35%, or from about 10% to about 75%, or from about 40% to about 95%, or from about 45% to about 75%, by weight of the alkyl polyglucoside may be C10 alkyl polyglucoside.

C8-C18 alkyl polyglucosides are commercially available from several suppliers (e.g., GLUCOPON® 425N, GLUCOPON® 600 CSUP, GLUCOPON® 650 EC, GLUCOPON® 600 CSUP/MB, GLUCOPON® 650 ECIMB from BASF Corporation; and SIMUSOL® surfactants from Seppic Corporation). GLUCOPON® 425N is a broad range alkyl polyglucoside surfactant.

The nonionic surfactant may be selected from the group consisting of a linear or branched C9-C15 ethoxylated alcohol surfactants having about 5 to about 12 units of ethylene oxide per mole of alcohol, C8-C18 alkyl polyglucoside surfactants having a number average degree of polymerization of from about 0.5 to about 3.0, preferably about 1 to about 2, and mixtures thereof.

### Amphoteric Surfactant

The car wash composition(s) may comprise from 0.01% to 10%, from 0.1% to 8%, from 0.15% to 5%, or different combinations of the upper and lower percentages described above or combinations of any value in the ranges listed above, by weight of the car wash composition of an amphoteric surfactant. Preferably, the amphoteric surfactant is an amine oxide.

The amine oxide may be linear or branched, though linear are preferred. Suitable linear amine oxides are typically water-soluble and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of methyl, ethyl, propyl, isopropyl, 2-hydroxyethyl, 2-hydroxypropyl and 3-hydroxypropyl, and mixtures thereof, though methyl is preferred for one or both of R2 and R3. The linear amine oxide surfactants, in particular, may include linear C10-C18 alkyl dimethyl amine oxides and linear C8-C12 alkoxy ethyl dihydroxy ethyl amine oxides.

Preferably, the amine oxide surfactant is selected from the group consisting of alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, or mixtures thereof. C12-C14 alkyl dimethyl amine oxide is particularly preferred.

### Zwitterionic Surfactant

The car wash composition(s) may comprise a zwitterionic surfactant. The car wash compositions disclosed herein may comprise from 0.01% to 10%, from 0.1% to 8%, from 0.15% to 5%, or different combinations of the upper and lower percentages described above or combinations of any value in the ranges listed above, by weight of the car wash composition of a zwitterionic surfactant. Suitable zwitterionic surfactants include betaine surfactants. Such betaine surfactants include alkyl betaines, alkylamidobetaine, amidazoliniumbetaine, sulphobetaine (INCI Sultaines) as well as the phosphobetaine, and preferably meets formula (I):

R1-[CO—X(CH2)ₙ]ₓ—N⁺(R2)(R3)-(CH₂)ₘ—[CH(OH)—CH₂]_{y}—Y—
wherein in formula (I),
R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;
X is selected from the group consisting of: NH, NR4 wherein R4 is a C1-4 alkyl residue, O, and S,
n is an integer from 1 to 10, preferably 2 to 5, more preferably 3,
x is 0 or 1, preferably 1,
R2 and R3 are independently selected from the group consisting of: a C1-4 alkyl residue, hydroxy substituted such as a hydroxyethyl, and mixtures thereof, preferably both R2 and R3 are methyl,
m is an integer from 1 to 4, preferably 1, 2 or 3,
y is 0 or 1, and
Y is selected from the group consisting of: COO, SO₃, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaine of formula (Ic) and the amido sulphobetaine of formula (Id):

R1-N⁺(CH₃)₂—CH₂COO— (Ia)

R1-CO—NH—(CH₂)₃—N⁺(CH₃)₂—CH₂COO— (Ib)

R1-N⁺(CH₃)₂—CH₂CH(OH)CH₂SO₃⁻ (Ic)

R1-CO—NH—(CH₂)₃—N⁺(CH₃)₂—CH₂CH(OH)CH₂SO₃⁻ (Id)

in which R1 has the same meaning as in formula (I). Particularly preferred are the carbobetaines [i.e., where Y═COO in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Hydrophobic Benefit Agent

The car wash composition(s) disclosed herein may comprise a hydrophobic benefit agent. The hydrophobic benefit agent may be selected from the group consisting of a wax, a silicone oil, and mixtures thereof. The compositions disclosed herein may comprise from about 0.1% to about 5.0%, preferably from about 0.1% to about 3.0%, by weight of the composition of a hydrophobic benefit agent.

Suitable waxes include vegetable waxes, such as carnauba wax, candelilla wax, and ouricury wax; mineral waxes such as montan wax, paraffin wax, and microcrystalline waxes; animal waxes such as beeswax; and synthetic waxes such as amide waxes and silicone waxes. Suitable silicone waxes include amino modified silicone waxes, such as Triplex silicones combining silicone and wax chemistry in one molecule, with a cationic (amino) modification. Triplex silicones are available from CHT Germany GmbH technology (e.g., ICM EM 1630). Combinations of two or more of the aforementioned waxes may be used. Carnauba wax is preferred.

Suitable silicone oils include polydimethylsiloxane, amino-functional silicone, and mixtures thereof.

### Stabilizing Agent

The car wash compositions disclosed herein may comprise a stabilizing agent, particularly compositions that comprise hydrophobic benefit agent. The car wash compositions may comprise from about 0.01% to about 0.8%, or about 0.01% to about 0.5%, or about 0.1% to about 0.5% by weight of the composition of a stabilizing agent. It is believed that the stabilizing agent helps to stabilize formulations containing hydrophobic agents, such as waxes, e.g., carnauba wax. For example, carnauba wax, which is a preferred wax, has a high melting point (about 85° C.). When carnauba wax is solubilized into a surfactant matrix, the wax may revert to a small crystalline wax particle, when cooled, and form a crystalized solid phase. This crystalized solid phase can phase separate, particularly in a low viscosity surfactant(s) and at temperatures of about 40° C. to 50° C. Such temperature fluctuations are possible in a garage, where car care products are commonly stored. The use of a phase unstable car wash product may lead to unintended performance disadvantages, versus a homogenous, stable car wash product. Homogeneous, stable formulations, which can withstand temperature fluctuations, are preferable.

Suitable stabilizing agents include crystalline stabilizing agents that can be categorized as acyl derivatives, long chain amine oxides, and mixtures thereof. Suitable stabilizing agents are described in U.S. Pat. No. 4,741,855. Suitable stabilizing agents include ethylene glycol esters of fatty acids having from about 16 to about 22 carbon atoms. Suitable stabilizing agents also include ethylene glycol stearates, both mono and distearate, and the distearate containing less than about 7% of the mono stearate.

The use of a hydrogenated castor oil stabilizing agent (such as trihydroxystearin, e.g., Thixcin R, supplied by Elementis Specialties) may contribute to improved formulation flexibility by producing (i) a dispersion having high concentration of the stabilizing agent (more efficient use of the plant vessels), and (ii) a crystal habit/form that results in a higher yield stress in the final product, imparting high stability, for a given amount stabilizing agent. Preferably, the stabilizing agent is trihydroxystearin.

### Perfume

The car wash compositions disclosed herein may comprise a perfume. The compositions may comprise from about 0.1% to about 3%, preferably from about 0.25% to about 2%, more preferably from about 0.5% to about 1.5% by weight of the total composition of a perfume. Perfume ingredients may include natural products such as extracts, essential oils, absolutes, resinoids, resins, concretes etc., and also synthetic basic substances such as hydrocarbons, alcohols, aldehydes, ketones, ethers, acids, esters, acetals, ketals, nitriles, etc., including saturated and unsaturated compounds, aliphatic, carbocyclic and heterocyclic compounds.

### Method of Washing

The compositions of the present disclosure may be used in methods of manually washing cars, preferably the exterior of car. Suitable methods may include the steps of diluting a car wash composition of the present disclosure in a volume of water to form a ready-to-use wash composition and contacting or immersing a first cleaning implement, such as a towel, a cloth, or a sponge, in the ready-to-use car wash composition. The first cleaning implement is then used to clean the car, preferably the exterior of the car. The exterior surface of the car may be dry before being contacted with the first cleaning implement. The amount of car wash composition that is diluted in water may be selected based on the judgment of the user and may depend upon, for example, the degree of soiling on the car. About 15 g to about 50 g of the car wash composition may be diluted in from about 4 L to about 8 L of water to form the ready-to-use car wash composition. The water may have a hardness of about 3 grains per gallon to about 16 grains per gallon.

The ready-to-use car wash composition may comprise from about 98% to about 99.999%, preferably from about 99% to about 99.99%, more preferably from about 99% to about 99.9%, by weight of the total composition of water. The ready-to-use car wash composition may comprise from about 99.00% to about 99.99% by weight of the composition of water, from about 0.001% to about 0.8%, preferably from about 0.002% to about 0.6% by weight of the composition of one or more surfactants, optionally, from about 0.000001% to about 0.2%, preferably from about 0.00001% to about 0.1%, more preferably from about 0.0001% to about 0.05%, by weight of the composition of a hydrophobic benefit agent selected from the group consisting of a wax, a silicone oil, and mixtures thereof, and, optionally, from about 0.000001% to about 0.01%, or from about 0.00001% to about 0.01%, trihydroxystearin, where the pH of the composition is about 6.5 to about 7.5. The ready-to-use car wash composition may comprise from about 0.001% to about 0.3%. preferably about 0.001% to about 0.2%, by weight of the ready-to-use car wash composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof, from about 0.001% to about 0.3%, or from about 0.01% to about 0.3%, by weight of the ready-to-use car wash composition of a nonionic surfactant selected from the group consisting of a linear or branched C9-C15 ethoxylated alcohol surfactant having about 5 to about 12 units of ethylene oxide per mole of alcohol, a C8-C16 alkyl polyglucoside surfactant having a number average degree of polymerization of from about 0.5 to about 3.0, preferably about 1 to about 2, and mixtures thereof, and from about 0.0001% to about 0.1%, or from about 0.001% to about 0.1%, by weight of the ready-to-use car wash composition of an amphoteric surfactant.

The first cleaning implement is contacted or immersed in the ready-to-use car wash composition, before scrubbing the soiled surface of the car with the cleaning implement, e.g., the first cleaning implement. The step of scrubbing the soiled surface of the car may take from about 10 seconds to about 10 minutes. The towel, cloth, sponge, or similar cleaning implement is typically contacted with or immersed in the water for a period of time ranging from 5 to 10 seconds, although the actual time may vary with each application and user preferences. During the step of scrubbing the car, soil may be removed from the car and transferred to the cleaning implement, e.g., the first cleaning implement. After the step of scrubbing the car, the soiled cleaning implement, e.g., the soiled first cleaning implement, may be contacted with or immersed in the ready-to-use car wash composition for a period of time ranging from 5 to 10 seconds, to remove the soils from the cleaning implement and contact the cleaning implement with additional car wash composition, so that the cleaning implement may be reused. The cleaning implement, e.g., the first cleaning implement, may optionally be used again to apply ready-to-use car wash composition to the car and to scrub the car to remove soil. Preferably, the methods of washing a car disclosed herein are free of a rinse step. For example, a rinse step may be avoided, when a soiled cleaning implement can be repeatedly contacted with or immersed in ready-to-use car wash composition (e.g., after each repeated scrubbing step) to remove the soils transferred from the car.

### Test Methods

### Rheological Measurement Method

The Rheological Measurement Method consists of measuring the equilibrium flow curve of a composition. To do this, the steady-state viscosity is measured as a function of the shear rate. The result of the measurement is visualized in a plot, where the shear rate is reported in 1/s on the x-axis and either the viscosity, in Pa s, or the shear stress, in Pa, is reported on the y-axis. The range of shear rates explored is from 100 to 0.01 1/s in a logarithmically spaced distribution with 10 points per decade. The resulting data are fitted with a rheological model using a standard non-linear regression optimization algorithm. The rheological model utilized is called the Three-Component Model (Caggioni, Marco, Veronique Trappe, and Patrick T. Spicer. “Variations of the Herschel-Bulkley exponent reflecting contributions of the viscous continuous phase to the shear rate-dependent stress of soft glassy materials.” Journal of Rheology 64.2 (2020): 413-422). One of the parameters of this model, the yield stress, indicates the strength of the permanent elastic microstructure in the composition; a particle dispersed in the composition that applies a gravitational stress on the microstructure that is less than the yield stress will stay suspended in the composition (Beris, A. N., et al. “Creeping motion of a sphere through a Bingham plastic.” Journal of Fluid Mechanics 158 (1985): 219-244).

pH

First, calibrate the Mettler Toledo Seven Compact pH meter. Do this by turning on the pH meter and waiting for 30 seconds. Then take the electrode out of the storage solution, rinse the electrode with distilled water, and carefully wipe the electrode with a scientific cleaning wipe, such as a Kimwipe®. Submerse the electrode in the pH 4 buffer and press the calibrate button. Wait until the pH icon stops flashing and press the calibrate button a second time. Rinse the electrode with distilled water and carefully wipe the electrode with a scientific cleaning wipe. Then submerse the electrode into the pH 7 buffer and press the calibrate button a second time. Wait until the pH icon stops flashing and press the calibrate button a third time. Rinse the electrode with distilled water and carefully wipe the electrode with a scientific cleaning wipe. Then submerse the electrode into the pH 10 buffer and press the calibrate button a third time. Wait until the pH icon stops flashing and press the measure button. Rinse the electrode with distilled water and carefully wipe with a scientific cleaning wipe. Submerse the electrode into the testing sample and press the read button. Wait until the pH icon stops flashing and record the value.

### Test for Measuring Speed to Lather Formation and Foam Stability

Foam quality of a sample may be measured by means of the foam creaminess and/or the foam stability of a sample. Foam creaminess and foam stability of a sample is measured by a foam analyzer instrument (such as Kruss DFA 100 Foam Analyzer, or equivalent). Materials that are required for the instrument set up includes (i) Kruss DFA 100 Foam Analyzer; (ii) SH4501—sparging column holder (iii) Sparging air methodology (iv) CY4572—Prism column (40 mm) with calibration grid for foam structure analyses; (v) Measuring cups; (vi) 25 ml and 5 ml syringes; (viii) Paper towels; and (vii) Water—Deionized water.

The instrument setup is described in the following steps: (i) Set camera height to 120 mm (camera is part of the Kruss DFA 100 Foam Analyzer); (ii) Set height illumination—λ=469 nm; (iii) Set camera distance at ‘position 3’; (iv) Adjust camera focus to 1.4; (v) Insert the SH4501 sparging head onto the column holder; (vi) Place the FI4531 O ring on top of filter FL4503 and one on bottom to create a water tight seal between the column holder and the column; (vii) Insert the assembled SH4501 column holder into the Kruss DFA 100 Foam Analyzer; (viii) Ensure the CY4572 prism column is accurately aligned straight towards the instrument; and (ix) View ‘Live camera’ from analysis software (analysis software comes together with the Kruss DFA 100 Foam Analyzer) to ensure camera is capturing unobstructed full view of the CY4572 prism column surface.

Each sample is prepared as follows. In a first step, using syringes, dilute the sample composition in 50 ml deionized water (which is the minimum amount required for analysis with the instrument). In a second step, the content in the measuring cup is gently mixed (do not create bubbles) until it becomes a homogenous solution. In a third step, using a syringe, gently add the homogenous solution into the CY4572 prism column to minimize bubble generation.

The analysis software program setup is described in the following steps: (i) check mark detection boxes containing height and structure program selection; (ii) Set live view and controls to Illumination height set to 12%, structure illumination set to 20%, flow rate set to 0.3 L/min, data sampling rates foaming height to 5 fps, structure 2 fps, decay height 5 fps, structure 2 fps; (iii) Set automation program to start foaming; (iv) Set automation program to stop foaming at 20 seconds; (v) Set automation program stop measuring at 260 seconds; (vi) initiate testing.

### Data Analysis and Interpretation

The rate (mm/s) of lather generation over 20 seconds is determined by graphing time (s) vs. foam height (mm). The slope of the data generated over 20 seconds is used to determine the rate of lather generation. The rate helps to determine how fast the lather is generated over 20 seconds according to the method executed as described above. The higher the slope value the quicker the rate of lather generation.

Based on the method executed as described above, foam stability is determined by calculating the delta mean bubble area. The mean bubble area final subtracted by the mean bubble area initial determines the mean delta mean bubble area (Foam Stability Value=Mean bubble area μm²−Mean bubble area μm². Generally, the greater the delta mean bubble area, the less stable the foam.

### Towel Rating Methodology

A plastic plate, a paper plate (including a paper plate with a wax coating), or a plastic tray may be utilized as a surface for cleaning (a proxy for the exterior surface of a car). 5 ml of dirt surrogate (Table 1) is placed onto the clean plate or tray. The plate is set aside to allow the dirt to air dry on the plate, for at least 4 hrs.

TABLE 1

| Ingredient | Concentration |
|---|---|
| Insoluble - Dust¹ | 1-5% |
| Vegetable Oil | 0.1-1% |
| Water | 20-30% |
| Isopropanol | 60-70% |
| Sodium Chloride | 0.1-1% |

¹Mixture of A1 Ultrafine Test Dust and ASHRAE Test Dust, both available from Powder Technology Inc.

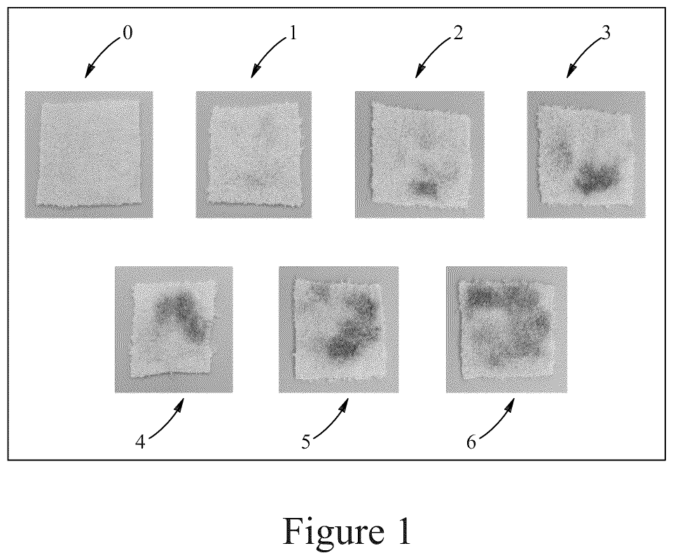

Kirkland® microfiber towels, having fiber compositions of 80% polyester/20% polyamide, are cut into 3 inch by 3 inch pieces. 0.75 g of each sample car wash composition is diluted into 100 ml of water, in a four ounce glass jar, to form a sample ready-to-use car wash composition, and mixed until homogenous. (i) Each 3×3 microfiber towel is dipped or immersed into the sample ready-to-use car wash composition. (ii) The towels are then wrung out until no longer dripping and used to clean or scrub the dirt-prepared plates, until all the dirt is visibly removed from the plates' surfaces. (iii) The soiled towels containing the dirt transferred from the plates are then immersed into the jars of sample ready-to-use car wash composition, with each towel immersed ten times. (iv) The towels are then wrung out until no longer dripping and the towels are then allowed to air dry, for at least 4 hrs. (v). The dried towels are then rated on a scale from 0 to 6 by comparing each towel to a reference scale, with 0 indicating a clean towel and 6 indicating the dirtiest towel, as shown in FIG. 1.

The reference scale is created via the following procedure: (i) a 10 ml disposable syringe is used to dispense 1 ml, 2 ml, 3 ml, 5 ml, 8 ml, and 10 ml of dirt surrogate to the surfaces of five clean plates and no dirt surrogate is applied to the surface of a sixth clean plate; (ii) the dirt surrogate is allowed to dry on each of the five plates; (iii) four ounce glass jars are filled with 100 ml of deionized water; (iv) six clean 3×3 microfiber towels are then immersed in the 100 ml of deionized water and wrung out until no longer dripping; (v) each of the six 3×3 microfiber towels is then used to wipe each of the six plates; (vi) after wiping, each reference towel is immersed into in a four ounce glass jar containing 100 ml of deionized water by dipping the towel in and out of the water ten times; (vii) the towels are then wrung out until no longer dripping and the towels are then allowed to air dry, for at least 4 hrs. Thus, the reference scale includes a “0” towel, which is used to wipe the plate that has no dirt, a “1” towel, which is used to wipe the plate that has 1 ml of dirt, a “2” towel, which is used to wipe the plate that has 2 ml dirt, a “3” towel, which is used to wipe the plate that has 3 ml dirt, a “4” towel, which is used to wipe the plate that has 5 ml dirt, a “5” towel, which is used to wipe the plate that has 8 ml dirt, and a “6” towel, which is used to wipe the plate that has 10 ml of dirt.

### High Temperature Stability

15 ml of sample composition is added to a 20 ml scintillation vial and placed into 40° C./20% relative humidity chamber for up to 90 days. Samples are visually evaluated for phase separation, where phase separation appears as a top hazy/milky phase separated from a clear bottom phase or a clear top phase that is separated from a bottom hazy/milky phase. If phase instability is observed, the sample is rated as a “fail” (F) and if no phase instability is observed, the is rated as a “pass” (P), for the specified time point.

### Consumer Test Methodology

A total of 116 consumer panelists are recruited and each consumer panelist conducts a three week usage test at home. Approximately half of the consumer panelists are considered exclusively “at home car washers” and approximately half of the consumer panelists are considered “hybrid car washers,” who wash both at home and at automated car washes. Each consumer panelist uses the test products two to three times over the three-week period. One bucket wash test products area single placed at a 50:50 split between male and female consumers.

One bucket wash test products are provided with yellow Kirkland® microfiber towels (80% polyester/20% polyamide). One bucket wash test products are also provided with usage directions that instruct the consumer panelists to: (i) add 1 cap (1 ounce) of car wash composition to 2 gallons of water; (ii) dip a microfiber towels into the bucket and ensure complete saturation; (iii) then, wring out the towel until it is no longer dripping but is very damp; (iv) use the damp towel to wash/scrub a single panel of a car's exterior surface at a time; (v) use a second dry, clean microfiber towel to wipe dry the washed area; (vi) repeat steps (ii)-(v) until the car is clean, rewetting and reusing the towel as needed. The one bucket wash test products are tested against ARMOR ALL® Ultra Shine Wash and Wax, a traditional car wash product, which is provided with traditional car wash usage instructions that instruct the consumer panelists to (i) use the product on a cool car, preferably in a shaded area to avoid water spotting; (ii) rinse the car first to remove loose dirt; (iii) then add the traditional car wash composition to a bucket of water, at a concentration of 1 ounce of composition per gallon of water, and mix; (iv) dip a sponge, a terry cloth, or a mitt into the bucket and (v) use the wet sponge, terry cloth, or mitt to wash/scrub the car; (vi) then, rinse car and dry immediately with a soft, dry terry cloth or chamois.

### Examples

Example formulations A-Q are made by mixing water, sodium benzoate, and the specified surfactants with an IKA overhead mixer at approximately 100 rpm. For formulations that contain carnauba wax, mixing (at approximately 100 rpm) continues and, at the same time, the mixture is heated to 86° C. Once the mixture reaches 86° C., the mixing continues and carnauba wax is added. When the carnauba wax is solubilized and the formula is visibly transparent, the mixing continues and the mixture is cooled to 35° C. Once the temperature of the mixture reaches 35° C., for formulation containing trihydroxystearin, mixing continues and the trihydroxystearin is added. If present, silicone and/or perfume are added along with the trihydroxystearin. The pH of the formulation batch is then adjusted using citric acid, if necessary, to a pH in the range of about 6 to about 9. Water may be added to account for water loss due to heating. Example formulations A-Q are tested to determine speed to lather, Kruss lather, towel rating, and phase stability, in accordance with the relevant test methods disclosed herein. The test results are shown in Tables 2, 3, and 4 and summarized below.

### Summary of Results

Formula A yields a towel rating of 3, which is greater than the towel rating of Formula B, which has a towel rating of 2, indicating that Formula A yields a dirtier towel than Formula B. Formula A contains an alkyl polyglucoside (GLUCOPON® 215UP) that has a narrower chain length distribution—C8 and C10, while Formula B contains an alkyl polyglucoside (GLUCOPON®425N) that has a broader chain length distribution—C8, C10, C12, C14, and C16. Similarly, Formula B yields a towel rating of 2, which is less than the towel rating of Formula C, which yields a towel rating of 3, indicating that Formula B yields a cleaner towel than Formula C. Formula C contains an alkyl polyglucoside (GLUCOPON® 600UP) that has a narrower chain length distribution—C12, C14, and C16, while Formula B, as noted above, contains an alkyl polyglucoside (GLUCOPON® 425N) that has a broader chain length distribution—C8, C10, C12, C14, and C16. Formula N contains a different alkyl polyglucoside (PLANTAREN® 2000) than Formula B (GLUCOPON® 425N). While PLANTAREN® 2000 is believed to have a chain length distribution similar to that of GLUCOPON® 425N—C8, C10, C12, C14, and C16, it is believed that PLANTAREN® 2000 may have a different number average carbon chain length and/or a different weight ratio of C8-10:C12-16 than GLUCOPON® 425N. Formula N yields a higher towel rating (3) than Formula B (2), indicating that Formula B yields a cleaner towel than Formula N. All in all, though, it is believed that a formulation containing an alkyl polyglucoside with a broader chain length distribution provides improved towel cleaning for a one bucket wash product, while other characteristics, such as number average carbon chain length, may also impact towel cleaning.

Formula M, which differs from Formula N in that it does not contain sodium lauryl sulfate or a stabilizing agent (Thixcin® R), is not phase stable, whereas Formula N is phase stable. Formula M yields a towel rating of (1), which is not improved upon by Formula N, which contains sodium lauryl sulfate but nonetheless yields a towel rating of (3).

The towel rating of Formula B, which is 2, is also less than the towel rating of Formula D, which has a towel rating of 3, indicating that Formula B yields a cleaner towel than Formula D. Formula B differs from Formula D in that Formula B contains sodium olefin sulfonate, while Formula D does not contain sodium olefin sulfonate. Thus, it is believed that the addition of sodium olefin sulfonate also improves towel cleaning for a one bucket wash product.

Formula E, which differs from Formula B in that Formula E contains a cationic terminal amino silicone (Y14957 TAS), at a concentration of 5 wt. %, yields a higher towel rating than Formula B. Formula E also does not pass the phase stability test. Formula F, which differs from Formula E in that Formula F contains a polydimethylsiloxane (Belsil® DM5500), at a concentration of 2 wt. %, yields a lower towel rating than Formula E, indicating that Formula F yields a cleaner towel than Formula E. In addition, Formula L, which differs from Formula F in that it has a greater concentration (5 wt. %) of polydimethylsiloxane (Belsil® DM5500), also yields a towel rating of 2, which is the same as Formula F and superior to Formula E, which contains the terminal amino silicone. Formula F and Formula L are also both phase stable. The phase stabilities and towel ratings of Formulas F and L indicate that polydimethylsiloxane is stabilized within both formulas and both formulas provide acceptable towel cleaning.

Moreover, Formula F demonstrates a rate of lather generation of 4.56 mm/sec and a mean bubble area Δ of 9,079 μm² (after 3 min), which indicates quicker lather generation and more stable lather than the traditional wash product ARMOR ALL® Ultra Shine Wash and Wax, with a rate of lather generation of 3.9 mm/sec and a mean bubble area Δ of 41,827 μm². Formula F also demonstrates quicker lather generation and more stable lather than a marketed one bucket wash product, CROFTGATE® Wash and Wax, with a lather generation of 3.86 mm/sec and mean bubble area Δ of 97,381 μm². Similarly, Formula L demonstrates a rate of lather generation of 5 mm/sec and a mean bubble area Δ of 9,302 μm² (after 3 min), which indicates quicker lather generation and more stable lather than the traditional wash product ARMOR ALL® Ultra Shine Wash and Wax (3.9 mm/sec, 41,827 μm²) and the marketed one bucket wash product CROFTGATE® Wash and Wax (3.86 mm/sec, 97,381 μm²).

Finally, the consumer test results for Formula F indicate that the formula, used in a one bucket wash method, provides greater overall method convenience and fewer water spots, at a 90% confidence, versus ARMOR ALL® Ultra Shine Wash and Wax, a traditional car wash product using a traditional car wash method. Consumer panelists also indicate that they would wash their cars more often using Formula F in a one bucket wash versus using ARMOR ALL® Ultra Shine Wash and Wax in a traditional car wash method, at a 90% confidence.

Formula P, which differs from Formula L in that it contains alcohol ethoxylate, as the nonionic surfactant, rather than alkyl polyglucoside (GLUCOPON® 425N), is not phase stable and yields a towel rating of 3. In comparison, Formula L is phase stable and yields a towel rating of 2. Formula P demonstrates a rate of lather generation of 4.27 mm/sec, which indicates quicker lather generation than the traditional wash product ARMOR ALL® Ultra Shine Wash and Wax, with a rate of lather generation of 3.9 mm/sec. Formula P demonstrates a mean bubble area Δ of 37,486 μm² (after 3 min), which is elevated and indicates worse lather stability. All in all, when comparing Formula P to Formula L, Formula L demonstrates superiority in terms of towel rating, phase stability, rate of lather generation, and lather stability. It is believed that alkyl polyglucoside is better at stabilizing a formulation containing 5% polydimethylsiloxane than alcohol ethoxylate (both Formula L and Formula P contain 5% polydimethylsiloxane).

Formula Q, which differs from Formula P in that it does not contain polydimethylsiloxane, is phase stable and yields a towel rating of 2. Formula Q demonstrates a rate of lather generation of 4.87 mm/sec and a mean bubble area Δ of 9,181 μm² (after 3 min), which indicates quicker lather generation and more stable lather than the traditional wash product ARMOR ALL® Ultra Shine Wash and Wax (3.9 mm/sec, 41,827 μm²) and the marketed one bucket wash product CROFTGATE® Wash and Wax (3.86 mm/sec, 97,381 μm²). Additionally, the consumer test results for Formula Q indicate that the formula, used in a one bucket wash method, provides greater overall method convenience, at a 90% confidence, and fewer water spots, at a 80% confidence, versus ARMOR ALL® Ultra Shine Wash and Wax, a traditional car wash product using a traditional car wash method. Consumer panelists also indicate that they would wash their cars more often using Formula Q in a one bucket wash versus using ARMOR ALL® Ultra Shine Wash and Wax in a traditional car wash method, at a 90% confidence. As noted elsewhere in the disclosure, unlike alkyl polyglucoside, alcohol ethoxylate may contain 1,4-dioxane by-product, which may be undesirable.

Formula G, which does not contain any nonionic surfactant and instead contains additional sodium olefin sulfonate (16 wt. % versus 4 wt % in Formula F), is phase stable and yields a towel rating of 2. However, it is believed that Formula G may generate excessive lather, e.g., on the car itself, and thereby provide an undesirable wash experience for consumers, in the one bucket wash context.

Formula H, which differs from Formula B in that it contains a greater concentration of carnauba wax (2.5 wt. %), is phase stable and has a towel rating of 1, indicating that the concentration of carnauba wax can be increased to 2.5 wt. % without sacrificing phase stability or towel rating. Formula H also demonstrates a rate of lather generation of 5 mm/sec and a mean bubble area Δ of 7,452 μm² (after 3 min), which indicates quicker lather generation and more stable lather than both the traditional wash product ARMOR ALL® Ultra Shine Wash and Wax product (3.9 mm/sec, 41,827 μm²) and the one bucket wash CROFTGATE® Wash and Wax product (3.86 mm/sec, 97,381 μm²).

Formula I, which differs from Formula B in that it does not contain any stabilizing agent (Thixcin® R), while still containing carnauba wax (0.4 wt. %), is not phase stable but has a towel rating of 1. Thus, a formula that contains wax but no stabilizing agent phase separates but still cleans the towel effectively in a one bucket wash context. Formula J, which differs from Formula B in that it does not contain any carnauba wax or stabilizing agent (Thixcin® R), is phase stable and transparent, and it cleans the towel effectively with a score of 1. Thus, a formula that contains no wax and no stabilizing agent may still clean a towel effectively in a one bucket wash context, but without providing a protective wax coating to the car.

Formula K, which contains a lower concentration of total surfactant (namely, a reduced concentration of alkyl polyglucoside (GLUCOPON® 425N), at 9.5 wt. %, a reduced concentration of lauramine oxide, at 0.6 wt. %, a reduced concentration of sodium olefin sulfonate, at 1.5 wt. %, and no sodium lauryl sulfate), no carnauba wax, and no stabilizing agent, is phase stable and transparent, and it yields a towel rating of 2, but without providing a protective wax coating to the car. Formula K also demonstrates a rate of lather generation of 4.9 mm/sec and a mean bubble area Δ of 8,303 μm² (after 3 min), which indicates quicker lather generation and more stable lather than both the traditional wash product ARMOR ALL® Ultra Shine Wash and Wax product (3.9 mm/sec, 41,827 μm²) and the one bucket wash CROFTGATE® Wash and Wax product (3.86 mm/sec, 97,381 μm²).

Finally, the consumer test results for Formula K indicate that the formula, used in a one bucket wash method, provides greater overall method convenience, at a 80% confidence, and fewer water spots, at a 90% confidence, versus ARMOR ALL® Ultra Shine Wash and Wax, a traditional car wash product using a traditional car wash method. Consumer panelists also indicate that they would wash their cars more often using Formula K in a one bucket wash versus using ARMOR ALL® Ultra Shine Wash and Wax in a traditional car wash method, at a 90% confidence.

Formula O, which contains no carnauba wax and contains a polydimethylsiloxane (Belsil® DM5500), at a concentration of 2 wt. %, is phase stable and yields a towel rating of 2. Formula 0 also demonstrates a rate of lather generation of 5.25 mm/sec and a mean bubble area Δ of 10,675 μm² (after 3 min), which indicates quicker lather generation and more stable lather than both the traditional wash product ARMOR ALL® Ultra Shine Wash and Wax product (3.9 mm/sec, 41,827 μm²) and the one bucket wash CROFTGATE® Wash and Wax product (3.86 mm/sec, 97,381 μm²).

Marketed traditional car wash compositions that contain carnauba wax yield higher towel ratings, indicating inferior towel cleaning, demonstrate slower rates of lather generation, and/or demonstrate greater mean bubble area Δs. For example, ARMOR ALL® Ultra Shine Wash and Wax yields a towel rating of 3, demonstrates a rate of lather generation of 3.96 mm/sec, and a mean bubble area Δ of 41,827 μm². Meguiars® Wash and Wax traditional car wash composition yields a towel rating of 5. CROFTGATE® Wash and Wax one bucket wash product yields an acceptable towel rating of 2, however the CROFTGATE® Wash and Wax formulation is not phase stable. Moreover, CROFTGATE® Wash and Wax demonstrates a rate of lather generation of 3.86 and a mean bubble area Δ of 97,381 μm² (indicating lather instability). OPTI® Wash and Wax one bucket wash product yields a towel rating of 5 and is not phase stable. Similarly, AMERICAN DETAILER®, when used as a one bucket wash, yields a towel rating of 6 and is not phase stable.

TABLE 2

| Ingredients (wt %) | A | B | C | D | E | F |
|---|---|---|---|---|---|---|
| Plantaren ® 2000¹ | | | | | | |
| Glucopon ® 215UP² | 12 | | | | | |
| Glucopon ® 425N³ | | 12 | | 12 | 12 | 12 |
| Glucopon ® 600UP⁴ | | | 12 | | | |
| C10-C12 Alcohol Ethoxylate | | | | | | |
| (EO8)⁵ | | | | | | |
| Sodium Lauryl Sulfate⁶ | 2.3 | 2.3 | 2.3 | 4.1 | 2.3 | 2.3 |
| Sodium Olefin Sulfonate⁷ | 4 | 4 | 4 | 0 | 4 | 4 |
| Lauramine Oxide⁸ | 1.8 | 1.8 | 1.8 | 1.8 | 1.8 | 1.8 |
| Trihydroxystearin⁹ | 0.1 | 0.1 | 0.1 | 0.1 | 0.1 | 0.1 |
| Kalwax ® 2442¹⁰ | 0.4 | 0.4 | 0.4 | 0.4 | 0.4 | 0.4 |
| Sodium Benzoate¹¹ | 0.8 | 0.8 | 0.8 | 0.8 | 0.8 | 0.8 |
| Citric acid¹² | pH 6-9 | pH 6-9 | pH 6-9 | pH 6-9 | pH 6-9 | pH 6-9 |
| Purified water | QS | QS | QS | QS | QS | QS |
| Belsil ® DM5500¹³ | | | | | | 2 |
| Y14957 TAS¹⁴ | | | | | 5 | |
| Perfume | | | | | | 1.25 |
| Speed to lather (rate of lather | | | | | | 4.56 |
| generation in (mm/sec), | | | | | | |
| measured over a range of 20 sec) | | | | | | |
| Kruss lather (mean bubble area | | | | | | 9079 |
| Δ, in μm², after 3 min) | | | | | | |
| Towel Rating (0-6) | 3 | 2 | 3 | 3 | 3 | 2 |
| Phase Stability | P | P | P | P | F | P |
| Total Surfactant | 20.1 | 20.1 | 20.1 | 17.9 | 20.1 | 20.1 |
| Use dilution (1 ounce into 2 | 0.0784 | 0.0784 | 0.0784 | 0.0698 | 0.0784 | 0.0784 |
| gallons of water) (0.39% | | | | | | |
| concentrate) | | | | | | |

TABLE 3

| Ingredients (wt %) | G | H | I | J | K | L |
|---|---|---|---|---|---|---|
| Plantaren ® 2000¹ | | | | | | |
| Glucopon ® 215UP² | | | | | | |
| Glucopon ® 425N³ | | 12 | 12 | 12 | 9.5 | 12 |
| Glucopon ® 600⁴ | | | | | | |
| C10-C12 Alcohol Ethoxylate | | | | | | |
| (EO8)⁵ | | | | | | |
| Sodium Lauryl Sulfate⁶ | 2.3 | 2.3 | 2.3 | 2.3 | | 2.3 |
| Sodium Olefin Sulfonate⁷ | 16 | 4 | 4 | 4 | 1.5 | 4 |
| Lauramine Oxide⁸ | 1.8 | 1.8 | 1.8 | 1.8 | 0.6 | 1.8 |
| Trihydroxystearin⁹ | 0.1 | 0.1 | | | | 0.1 |
| Kalwax ® 2442¹⁰ | 0.4 | 2.5 | 0.4 | | | 0.4 |
| Sodium Benzoate¹¹ | 0.8 | 0.8 | 0.8 | 0.8 | 0.8 | 0.8 |
| Citric acid¹² | pH 6-9 | pH 6-9 | pH 6-9 | pH 6-9 | pH 6-9 | 6-9 |
| Purified water | QS | QS | QS | QS | QS | QS |
| Belsil ® DM5500¹³ | | | | | | 5 |
| Y14957 TAS¹⁴ | | | | | | |
| Speed to lather (rate of lather | NA | 5 | | | 4.99 | 5 |
| generation in (mm/sec), | | | | | | |
| measured over a range of 20 sec) | | | | | | |
| Kruss lather (mean bubble area | NA | 7452 | | | 8303 | 9302 |
| Δ, in μm², after 3 min) | | | | | | |
| Towel Rating (0-6) | 2 | 1 | 1 | 1 | 2 | 2 |
| Phase Stability | P | P | F | P | P | P |
| Total Surfactant | 20.1 | 20.1 | 20.1 | 20.1 | 11.6 | 20.1 |
| Use dilution (1 ounce into 2 | 0.0784 | 0.0784 | 0.0784 | 0.0784 | 0.0452 | 0.0784 |
| gallons of water) (0.39% | | | | | | |
| concentrate) | | | | | | |

TABLE 4

| Ingredients (wt %) | M | N | O | P | Q |
|---|---|---|---|---|---|
| Plantaren ® 2000¹ | 12 | 12 | | | |
| Glucopon ® 215UP² | | | | | |
| Glucopon ® 425N³ | | | 12 | | |
| Glucopon ® 600⁴ | | | | | |
| C10-C12 Alcohol Ethoxylate | | | | 12 | 12 |
| (EO8)⁵ | | | | | |
| Sodium Lauryl Sulfate⁶ | | 2.3 | 2.3 | 2.3 | 2.3 |
| Sodium Olefin Sulfonate⁷ | 4 | 4 | 4 | 4 | 4 |
| Lauramine Oxide⁸ | 1.8 | 1.8 | 1.8 | 1.8 | 1.8 |
| Trihydroxystearin⁹ | | 0.1 | 0.1 | 0.1 | 0.1 |
| Kalwax ® 2442¹⁰ | 0.4 | 0.4 | | 0.4 | 0.4 |
| Sodium Benzoate¹¹ | 0.8 | 0.8 | 0.8 | 0.8 | 0.8 |
| Citric acid¹² | pH 6-9 | pH 6-9 | pH 6-9 | pH 6-9 | pH 6-9 |
| Purified water | QS | QS | QS | QS | QS |
| Belsil ® DM5500¹³ | | | 2 | 5 | |
| Y14957 TAS¹⁴ | | | | | |
| Speed to lather (rate of lather | | | 5.25 | 4.27 | 4.87 |
| generation in (mm/sec), | | | | | |
| measured over a range of 20 | | | | | |
| sec) | | | | | |
| Kruss lather (mean bubble area | | | 10675 | 37486 | 9141 |
| Δ, in μm², after 3 min) | | | | | |
| Towel Rating (0-6) | 1 | 3 | 2 | 3 | 2 |
| Phase Stability | F | P | P | F | P |
| Total Surfactant | 17.8 | 20.1 | 20.1 | 20.1 | 20.1 |
| Use dilution (1 ounce into 2 | 0.0694 | 0.0784 | 0.0784 | 0.0784 | 0.0784 |
| gallons of water) (0.39% | | | | | |
| concentrate) | | | | | |

Ingredient Key ¹ Decyl Glucoside, from BASF.² Caprylyl/Myristyl Glucoside, from BASF.³ Caprylyl/Myristyl Glucoside, from BASF.⁴ Lauryl/Myristyl Glucoside, from BASF.⁵ C10-C12 Alcohol Ethoxylate (Tomadol® 91-8), from Evonik.⁶ Available from Stepan Company.⁷ Bio-Terg® AS40-HP from Stepan Company.⁸ Available from P&G Chemicals.⁹ Thixcin® R, from Elementis Specialties.¹⁰ Carnauba wax, from KahlWax¹¹ Available from P&G Chemicals.¹² Available from Archer Daniels Midland.¹⁴ Dimethiconol and Dimethicone, from Wacker.¹⁴ Terminal amino silicone, from Momentive.

TABLE 5

| | ARMOR ALL ® | | | | |
|---|---|---|---|---|---|
| | Ultra Shine | Meguiars ® | CROFTGATE | OPTI Wash | AMERICAN |
| | Wash and Wax | Wash and Wax | Wash and Wax | and Wax | DETAILER |
| | (traditional car | (traditional car | (one bucket | (one bucket | (one bucket |
| | wash product) | wash product) | wash product) | wash product) | wash product) |
| Carnauba wax | Yes | Yes | Yes | Yes | Yes |
| listed on label | | | | | |
| Speed to lather | 3.96 | N/A | 3.86 | N/A | N/A |
| (rate of lather | | | | | |
| generation | | | | | |
| in (mm/sec), | | | | | |
| measured over | | | | | |
| a range of | | | | | |
| 20 sec) | | | | | |
| Kruss lather | 41827 | N/A | 97381 | N/A | N/A |
| (mean bubble | | | | | |
| area Δ, in μm², | | | | | |
| after 3 min) | | | | | |
| Towel Rating | 3 | 5 | 2 | 5 | 6 |
| (0-6) | | | | | |
| Phase Stability | P | P | F | F | F |

Consumer Test Results for Example Formulas F, K, and Q versus ARMOR ALL® Ultra Shine Wash and Wax

One bucket wash Formulas F, K, and Q, all according to the present disclosure, and ARMOR ALL® Ultra Shine Wash and Wax, a traditional car wash product, are tested by consumers, as described above. The resultant consumer data on the one bucket wash test formulas is compared to the resultant consumer data on the ARMOR ALL® Ultra Shine Wash and Wax products and statistical relevance is determined. For example, as shown in Table 6 below, for Formula F, 63 out of 102 consumers rated the product as overall convenient, while for ARMOR ALL® Ultra Shine Wash and Wax, only 39 consumers rated the product as overall convenient (and 63 is statistically relevant at a 90% confidence interval versus 39). The other two scores—“fewer water spots” and “would wash car more often”—are responses on a 2+ to 2− agreement scale, where the score shown in Table 6 is an average agreement to the question asked about fewer water spots or washing more often on the 2+ to 2− agreement scale. For example, as shown in Table 6 below, for Formula F, the average agreement to the question asked about fewer water spots on the 2+ to 2− agreement scale is 1.36, while for ARMOR ALL® Ultra Shine Wash and Wax, the average agreement is 1.13 (and 1.36 is statistically relevant at a 90% confidence interval versus 1.13). In Table 6, “x” indicates an 80% confidence, the “X” indicates a 90% confidence, and “n” is the sample size.

TABLE 6

| | ARMOR ALL ® | | | |
|---|---|---|---|---|
| | Ultra Shine | | | |
| Consumer Test | Wash and Wax | F | K | Q |
| Question | (n = 109) | (n = 102) | (n = 100) | (n = 98) |
| Overall | 39 | 63X | 50x | 55X |
| convenience | | | | |
| Fewer water | 1.13 | 1.36X | 1.32X | 1.28x |
| spots | | | | |
| Would wash car | 0.77 | 1.45X | 1.5X | 1.26X |
| more often | | | | |

### Combinations

A. A car wash composition comprising:
a. from about 1% to about 30% by weight of the composition of one or more surfactants, wherein the one or more surfactants comprise:
   i. from about 1% to about 15%, preferably about 2% to about 10%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
   ii. from about 1% to about 15% by weight of the composition of a nonionic surfactant selected from the group consisting of a linear or branched C9-C15 ethoxylated alcohol surfactant having about 5 to about 12 units of ethylene oxide per mole of alcohol, a C8-C16 alkyl polyglucoside, preferably wherein about 10% to about 75% by weight of the C8-C16 alkyl polyglucoside is C10 alkyl polyglucoside, having a number average degree of polymerization of from about 0.5 to about 3.0, preferably about 1.0 to about 2.0, and mixtures thereof; and
   iii. from about 0.1% to about 5% by weight of the composition of an amphoteric surfactant;
b. from about 0.1% to about 5% by weight of the composition of a hydrophobic benefit agent selected from the group consisting of a wax, a silicone oil, and mixtures thereof;
c. from about 0.01% to about 0.5% trihydroxystearin; and
d. water;
wherein the pH of the composition is about 6 to about 9.
   B. A car wash composition comprising:
a. from about 1% to about 30% by weight of the composition of one or more surfactants, wherein the one or more surfactants comprise:
   i. from about 1% to about 15%, preferably about 2% to about 10%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
   ii. from about 1% to about 15% by weight of the composition of a C8-C16 alkyl polyglucoside, preferably wherein about 10% to about 75% by weight of the C8-C16 alkyl polyglucoside is C10 alkyl polyglucoside, having a number average degree of polymerization of from about 0.5 to about 3.0, preferably about 1.0 to about 2.0; and
   iii. from about 0.1% to about 5% by weight of the composition of an amphoteric surfactant;
   wherein the pH of the composition is about 6 to about 9.
      C. The car wash composition according to paragraph A or B, wherein the alkyl polyglucoside surfactant comprises C10 polyglucoside, C12 polyglucoside, or a combination thereof.
      D. The car wash composition according to paragraph B, wherein the composition further comprises from about 0.1% to about 5% by weight of the composition of a hydrophobic benefit agent selected from the group consisting of a wax, a silicone oil, and mixtures thereof.
      E. The car wash composition according to paragraph D, wherein the composition further comprises from about 0.01% to about 0.5% by weight of the composition of a stabilizing agent.
      F. The car wash composition according to paragraph E, wherein the stabilizing agent is trihydroxystearin.
      G. The car wash composition according to paragraph A or D, wherein the wax is selected from the group consisting of a vegetable wax, a mineral wax, an animal wax, a synthetic wax, and combinations thereof.
      H. The car wash composition according to paragraph A or D, wherein the wax is selected from the group consisting of a carnauba wax, candelilla wax, ouricury wax, montan wax, paraffin wax, microcrystalline wax, beeswax, an amide wax, a silicone wax, and combinations thereof.
      I. The car wash composition according to paragraph A or D, wherein the silicone oil is selected from the group consisting of polydimethylsiloxane, an amino-functional silicone, and mixtures thereof.
      J. The car wash composition according to paragraph A or B, wherein the anionic surfactant is selected from the group consisting of alpha-olefinsulfonate, alkyl sulfate, and mixtures thereof.
      K. The car wash composition according to paragraph J, wherein the alkyl sulfate has an average alkyl carbon chain length of about 10 carbon atoms to about 16 carbon atoms, preferably the alkyl sulfate is dodecyl sulfate.
      L. The car wash composition according to paragraph A or B, wherein the amphoteric surfactant is an amine oxide.
      M. The car wash composition according to paragraph L, wherein the amphoteric surfactant is selected from the group consisting of alkyl dimethyl amine oxide, alkyl amido propyl dimethyl amine oxide, and mixtures thereof, preferably the amphoteric surfactant is a C12-C14 dimethyl amine oxide.
      N. The car wash composition according to paragraph A or B, wherein the weight ratio of nonionic surfactant to anionic surfactant is from about 2:1 to about 20:1, preferably about 2:1 to about 10:1, more preferably about 2:1 to about 5:1.
      O. The car wash composition according to paragraph A or B, wherein the composition has a viscosity of from about 1 mPa·s to about 500 mPa·s, at a shear rate of 10 1/sec and at 40° C., as measured according to the Rheological Measurement Method disclosed herein.
      P. A method of manually washing a car comprising the steps of:
a. providing the car wash composition according to any one of the preceding claims;
b. diluting from about 15 g to about 50 g of the car wash composition, preferably in about 4 L to about 8 L of water, to obtain a wash solution; and
c. applying the wash solution to a car, preferably a dry exterior surface of a car, using a first cleaning implement, preferably a towel, to remove soil from the car.
   Q. The method according to paragraph P, further comprising a step(s), subsequent to step c), of wiping the wash solution off the car with a second cleaning implement, preferably a dry second implement, more preferably a dry towel.
   R. The method according to paragraph P or Q, further comprising a step(s), subsequent to step c), of contacting the soiled first cleaning implement with the wash solution to remove the soils from the first cleaning implement and, optionally, reusing the first cleaning implement to apply wash solution to the car.
   S. The method according to paragraph P, Q, or R, wherein the method is free of a rinse step.
   T. The method according to paragraph P, Q, R, or S, wherein the water has hardness of about 3 grains per gallon to about 16 grains per gallon.
   U. A ready-to-use car wash composition comprising:
a. from about 99.00% to about 99.99% by weight of the composition of water;
b. from about 0.0021% to about 0.6% by weight of the composition of one or more surfactants comprising:
   i. from about 0.001% to about 0.3%, preferably about 0.001% to about 0.2%, by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
   ii. from about 0.001% to about 0.3% by weight of the composition of a nonionic surfactant selected from the group consisting of a linear or branched C9-C15 ethoxylated alcohol surfactant having about 5 to about 12 units of ethylene oxide per mole of alcohol, a C10 alkyl polyglucoside surfactant having a number average degree of polymerization of from about 0.5 to about 3.0, preferably about 1 to about 2, and mixtures thereof; and
   iii. from about 0.0001% to about 0.1% by weight of the composition of an amphoteric surfactant;
c. from about 0.00001% to about 0.1% by weight of the composition of a hydrophobic benefit agent selected from the group consisting of a wax, a silicone oil, and mixtures thereof; and
d. from about 0.000001% to about 0.01% trihydroxystearin;
wherein the pH of the composition is about 6.5 to about 7.5.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A car wash composition comprising:
a. from about 1% to about 30% by weight of the composition of one or more surfactants, wherein the one or more surfactants comprise:
i. from about 1% to about 15% by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
ii. from about 1% to about 15% by weight of the composition of a nonionic surfactant selected from the group consisting of a linear or branched C9-C15 ethoxylated alcohol surfactant having about 5 to about 12 units of ethylene oxide per mole of alcohol, a C8-C16 alkyl polyglucoside having a number average degree of polymerization of from about 0.5 to about 3.0, and mixtures thereof; and
iii. from about 0.1% to about 5% by weight of the composition of an amphoteric surfactant;
b. from about 0.1% to about 5% by weight of the composition of a hydrophobic benefit agent selected from the group consisting of a wax, a silicone oil, and mixtures thereof;
c. from about 0.01% to about 0.5% trihydroxystearin; and
d. water;
wherein the pH of the composition is about 6 to about 9.

2. The car wash composition according to claim 1, wherein the weight ratio of nonionic surfactant to anionic surfactant is from about 2:1 to about 20:1.

3. The car wash composition according to claim 1, wherein the anionic surfactant is selected from the group consisting of alpha-olefinsulfonate, alkyl sulfate, and mixtures thereof.

4. The car wash composition according to claim 3, wherein the alkyl sulfate has an average alkyl carbon chain length of about 10 carbon atoms to about 16 carbon atoms, preferably the alkyl sulfate is dodecyl sulfate.

5. A car wash composition comprising:
a. from about 1% to about 30% by weight of the composition of one or more surfactants, wherein the one or more surfactants comprise:
i. from about 1% to about 15% by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
ii. from about 1% to about 15% by weight of the composition of a C8-C16 alkyl polyglucoside having a number average degree of polymerization of from about 0.5 to about 3.0; and
iii. from about 0.1% to about 5% by weight of the composition of an amphoteric surfactant;
wherein the pH of the composition is about 6 to about 9.

6. The car wash composition according to claim 5, wherein the alkyl polyglucoside surfactant comprises C10 polyglucoside, C12 polyglucoside, or a combination thereof.

7. The car wash composition according to claim 5, wherein the composition further comprises a hydrophobic benefit agent selected from the group consisting of a wax, a silicone oil, and mixtures thereof.

8. The car wash composition according to claim 7, wherein the composition further comprises from about 0.01% to about 0.5% by weight of the composition of a stabilizing agent.

9. The car wash composition according to claim 8, wherein the stabilizing agent is trihydroxystearin.

10. The car wash composition according to claim 7, wherein the wax is selected from the group consisting of a vegetable wax, a mineral wax, an animal wax, a synthetic wax, and combinations thereof.

11. The car wash composition according to claim 7, wherein the wax is selected from the group consisting of a carnauba wax, candelilla wax, ouricury wax, montan wax, paraffin wax, microcrystalline wax, beeswax, an amide wax, a silicone wax, and combinations thereof.

12. The car wash composition according to claim 7, wherein the silicone oil is selected from the group consisting of polydimethylsiloxane, an amino-functional silicone, and mixtures thereof.

13. The car wash composition according to claim 5, wherein the amphoteric surfactant is an amine oxide.

14. The car wash composition according to claim 13, wherein the amphoteric surfactant is selected from the group consisting of alkyl dimethyl amine oxide, alkyl amido propyl dimethyl amine oxide, and mixtures thereof.

15. The car wash composition according to claim 5, wherein the weight ratio of nonionic surfactant to anionic surfactant is from about 2:1 to about 20:1.

16. A method of manually washing a car comprising the steps of:
a. providing the car wash composition according to claim 1;
b. diluting from about 15 g to about 50 g of the car wash composition, to obtain a wash solution; and
c. applying the wash solution to a car, preferably a dry exterior surface of a car, using a first cleaning implement, preferably a towel, to remove soil from the car.

17. The method according to claim 16, further comprising a step(s), subsequent to step c), of wiping the wash solution off the car with a second cleaning implement, preferably a dry second implement.

18. The method according to claim 17, further comprising a step(s), subsequent to step c), of contacting the soiled first cleaning implement with the wash solution to remove the soils from the first cleaning implement and, optionally, reusing the first cleaning implement to apply wash solution to the car.

19. The method according to claim 16, wherein the method is free of a rinse step.

20. A ready-to-use car wash composition comprising:
a. from about 99.00% to about 99.99% by weight of the composition of water;
b. from about 0.0021% to about 0.6% by weight of the composition of one or more surfactants comprising:
i. from about 0.001% to about 0.3% by weight of the composition of an anionic surfactant selected from the group consisting of linear alkylbenzenesulfonate, alpha-olefinsulfonate, alkyl sulfate, alcohol ethoxysulfate, secondary alkanesulfonates, alpha-sulfo fatty acid methyl esters, alkyl- or alkenylsuccinic acid, soap, and mixtures thereof;
ii. from about 0.001% to about 0.3% by weight of the composition of a nonionic surfactant selected from the group consisting of a linear or branched C9-C15 ethoxylated alcohol surfactant having about 5 to about 12 units of ethylene oxide per mole of alcohol, a C10 alkyl polyglucoside surfactant having a number average degree of polymerization of from about 0.5 to about 3.0, and mixtures thereof; and
iii. from about 0.0001% to about 0.1% by weight of the composition of an amphoteric surfactant;
c. from about 0.00001% to about 0.1% by weight of the composition of a hydrophobic benefit agent selected from the group consisting of a wax, a silicone oil, and mixtures thereof; and
d. from about 0.000001% to about 0.01% trihydroxystearin;
wherein the pH of the composition is about 6.5 to about 7.5.
